(19) United States
(12) Patent Application Publication
(10) Pub. No.: US 2013/0018794 A1
(43) Pub. Date: Jan. 17, 2013

(54) MOBILE COMMUNICATION DEVICE BASED MONETARY TRANSFER SYSTEM

(71) Applicants: Paul Jonathan Ungerland, II, Centennial, CO (US); Daniel R. Micale, San Diego, CA (US); Mark B. Lau, Superior, CO (US)

(72) Inventors: Paul Jonathan Ungerland, II, Centennial, CO (US); Daniel R. Micale, San Diego, CA (US); Mark B. Lau, Superior, CO (US)

(73) Assignee: NetQash LLC, Superior, CO (US)

(21) Appl. No.: 13/547,560

(22) Filed: Jul. 12, 2012

Related U.S. Application Data
(60) Provisional application No. 61/507,143, filed on Jul. 13, 2011.

(51) Int. Cl. G06Q 20/42; G06Q 20/40

(52) U.S. Cl. 705/44; 705/39

(57) ABSTRACT

Systems and methods are disclosed for performing transactions using secure images. A device may collect transaction details and initiates the creation of a secure image. Upon creation of the secure image, the device may provide the secure image to second device participating in the transaction by displaying the secure image in a manner that allows the second device to capture the secure image or by providing the secure image in an electronic message. The second device may use the secure image to identify the transaction by providing the secure image to a secure server. Upon receiving the secure image, the secure server may provide transaction details to the second device. The second device may then send a confirmation of the transaction to the secure server, which may then complete the transaction. Use of the secure image allows the transaction to be performed without exposing sensitive transaction details.

### RELATED APPLICATIONS

This application claims priority to U.S. Provisional Patent Application No. 61/507,143, entitled “Mobile Communication Device Based Monetary Transfer System,” filed on Jul. 13, 2011, which is hereby incorporated by reference in its entirety.

### BACKGROUND

Multi-functional mobile communication devices have become standard devices carried by users. As mobile technology continues to progress mobile devices are commonly equipped with digital image capabilities. Mobile communication devices are increasingly capable of connecting to other devices over a network. The ubiquity of such devices provides an opportunity to utilize the devices to perform transactions that previously were limited to private networks. It is with respect to this general environment that embodiments of the present disclosure have been contemplated.

### SUMMARY

Embodiments of the present disclosure relate to using mobile communication devices to complete transactions in person-to-person, person-to-business, and business-to-business transactions. The transactions may be performed by a human interacting with a device or two or more devices interacting with each other. In embodiments, the transactions may be financial transactions; however, other types of transactions may be performed using the systems and methods disclosed herein. In embodiments, an application on the mobile device may be capable of reading and processing a secure image, such as a Secure Transaction Image (STI) or Payment Data Image (PDI) code, modifying and storing information associated with the secure image, and completing a transaction using the secure image.

The embodiments disclosed herein may be utilized to transfer funds between two parties without relying upon the current credit/debit card transaction networks. For example, the embodiments disclosed herein allow users to securely complete financial transactions over an open network, such as, but not limited to, the Internet. This allows parties to complete financial transactions without reliance upon credit and debit cards.

In one embodiment, systems and methods are provided that may be used to initiate a transaction. For example, a method performed by a payee, or merchant, device may begin a transaction by receiving transaction details and initiating the creation of a secure image. In embodiments, the secure image may be created by a remote device, such as a server, communicating with the device. Upon receiving the secure image from the server, the device may make the secure image available to one or more other devices participating in a transaction. The secure image may be provided to one or more other devices by displaying the secure image or by sending the secure image in an electronic message.

In other embodiments, systems and methods are provided that may be used to complete a transaction. For example, a method performed by a payor, or customer, device may initiate the completion of a transaction by receiving the secure image from a payee device. The device may receive the secure image by capturing a copy of a displayed secure image using a camera or scanner. The device may also receive the secure image in an electronic message. The received secure image may then be provided to a remote device, such as a server communicating with the device, as a candidate image. Upon verification of the candidate image, the device receives the transaction details which can be modified by a user prior to confirming the transaction. The device can then receive a confirmation by the user and provide the confirmation to one or more remote devices.

Additional embodiments provide systems and methods for facilitating a transaction between two parties. A device may receive transaction details and a request to create a secure image. In response to receiving the request, the device may create the secure image and associate it with a transaction and/or transaction details. The secure image may then be provided to one or more devices that are participating in the transaction. At a later time, the device may receive a candidate image. The device may verify the candidate image to determine that it is a secure image associated with a transaction and/or transaction data. The transaction data may be provided to one or more devices. The device may then receive a confirmation of the transaction and take any actions necessary to complete the transaction.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 is an embodiment of a system 100 that may be employed to perform a transaction using a secure image.

FIG. 2 is an embodiment of a flow chart illustrating a method 200 for registering entities and devices with a core transaction engine.

FIG. 3 is an embodiment of a flow chart illustrating a method 300 for initiating a transaction using a device.

FIG. 4 is a flowchart illustrating an embodiment of a method 400 for implementing a user interface for a payee device.

FIG. 5 is an embodiment of an exemplary transaction details form 500.

FIG. 6 is an exemplary embodiment of screenshot of a secure image display 600.

FIG. 7 is an exemplary embodiment of a send screen 700.

FIG. 8 is an embodiment of an exemplary transaction status screen 800.

FIG. 9 is flowchart illustrating an embodiment of a method 900 that may be employed by a device to complete a transaction.

FIG. 10 is a flowchart illustrating an embodiment of a method 1000 for implementing a user interface for a device to complete a transaction.

FIG. 11 is an exemplary embodiment of a user interface 1100 that may be used to capture a secure image.

FIG. 12 is an exemplary embodiment of a transaction details screen 1200 that displays transaction details for completing a transaction.

FIG. 13 is an embodiment of an exemplary transaction status screen 1300.

FIG. 14 is a flowchart illustrating an embodiment of a method 1400 for responding to a request to initiate a transaction.

FIG. 15 is a flow chart illustrating an embodiment of a method 1500 for responding to a request to complete a transaction.

FIG. 16 is an embodiment of a method 1600 for performing a method of creating a secure image.

FIG. 17 is an embodiment of a computing environment for implementing the various embodiments described herein.

### DETAILED DESCRIPTION

Embodiments of the present disclosure relate to using mobile communication devices to complete transactions in person-to-person, person-to-business, and business-to-business transactions. The transactions may be performed by a human interacting with a device or two or more devices interacting with each other. For example, the transactions disclosed herein may be accomplished through human/machine interaction, machine/machine interaction, etc. In embodiments, the transactions may be financial transactions; however, other types of transactions may be performed using the systems and methods disclosed herein. In embodiments, an application on the mobile device may be capable of reading and processing a secure image, such as a Secure Transaction Image (STI) or PDI code, modifying and storing information associated with the secure image, and completing a transaction using the secure image.

The embodiments disclosed herein may be utilized to transfer funds between two parties without relying upon the current credit/debit card transaction networks. For example, the embodiments disclosed herein allow users to securely complete financial transactions over a network, including an open network, such as, but not limited to, the Internet. This allows parties to complete financial transactions without reliance upon credit and debit cards and without exposing potentially sensitive financial information.

The systems and methods disclosed herein provide for affordable and scalable solutions to establish local, national, and international transaction processing networks. In embodiments related to the financial sector, the systems and methods disclosed herein may be used to establish payment processing networks by connecting financial institutions directly with consumers and customers via an open network connection, such as the Internet. Mobile device operated by the users may connect to the network and perform financial transactions without reliance upon current credit and debit card networks.

In embodiments, security may be maintained by using a secure image to identify transactions and transaction details. A secure image may uniquely identify a transaction and/or transaction details without exposing any sensitive user information, such as user financial information. In embodiments, participants in the transaction may initiate and complete the transaction using a secure image, thereby securing the transaction and obscuring sensitive information from interference and/or interception by an unauthorized party.

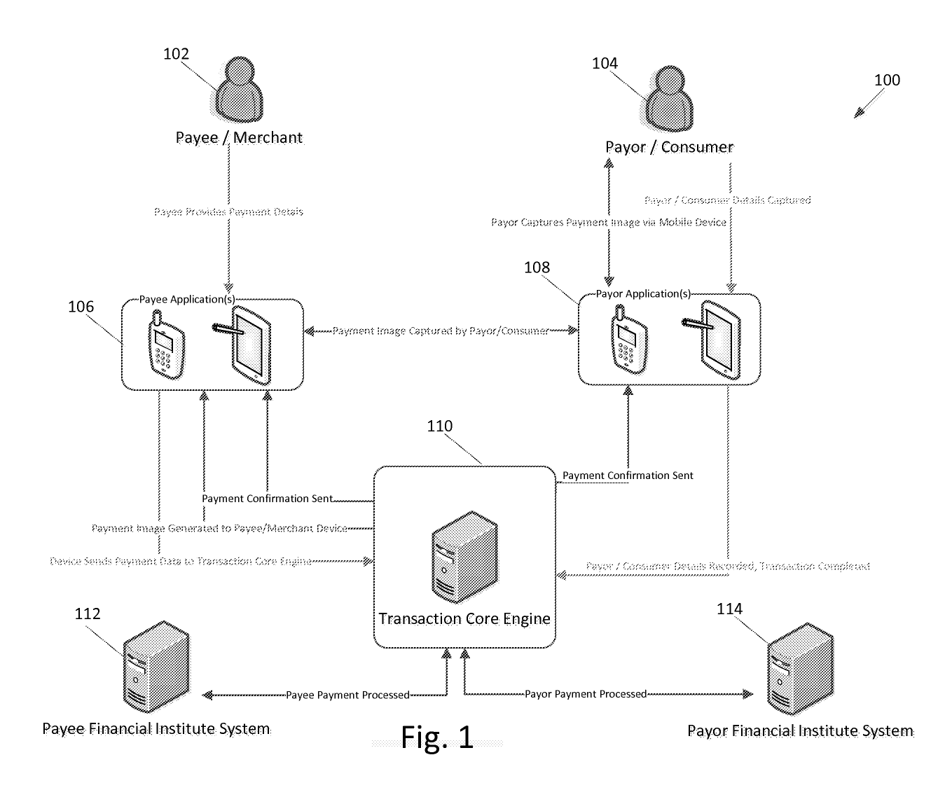

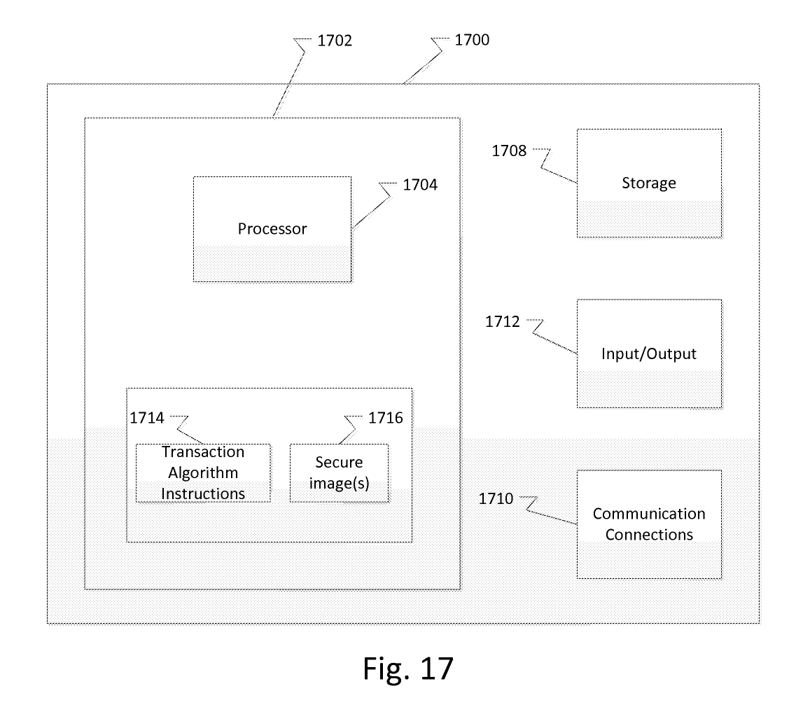

FIG. 1 is an embodiment of a system 100 that may be employed to perform a transaction using a secure image. For ease of discussion, the following discussion is described as performing a financial transaction. However, one of skill in the art will appreciate that other types of transactions may be performed using the system 100. In embodiments, a party to a transaction may register with a trusted server, such as one or more servers that form a transaction core 110. In embodiments, registration may include creating an account with the trusted server. The account may be associated with data about the party associated with the account. In embodiments, data may include information such as, but not limited to, user name, first name, middle name, last name, address, mobile device information, one or more phone numbers, one or more email addresses, checking account details, savings account details, credit and/or debit card information, or any other information related to a party. A first party to a transaction 102 (e.g., a payee) initiates a transaction with a second party 104 (e.g., a payor). A payee device 106 receives transaction details via user 102 interaction with a graphical user interface (GUI). In embodiments, a payee device 106 may be a mobile device, a smart phone, a tablet computer, a cell phone, a laptop, a computer, or any other type of general computing device, such as described with respect to FIG. 17. In embodiments, any device capable of an Internet or network connection and the ability to display and/or capture a secure image may be utilized as part of the systems and/or methods disclosed herein. Upon receipt of the transaction details, payee device 106 sends transaction details to a transaction core engine 110 via a network (not shown). In embodiments, a network may be a cellular network, a WiFi network, a POTS network, a WAN, a LAN, the Internet, or any other type of network. In embodiments, transaction core engine 110 may comprise one or more servers and/or computing devices capable of receiving and processing data related to a transaction. In embodiments, upon receiving the transaction details, transaction core engine 110 creates a unique, secure image that may be used to securely identify the transaction and/or transaction details. In embodiments, the transaction core engine 110 may store the transaction details and associate the secure image with the transaction details, thereby providing for the identification of transaction details with the secure image.

The transaction core engine 110 may then provide the secure image to payee device 106. Upon receiving the secure image, the payee device may provide the secure image to a payor device 108. For example, the payee device may send the secure image in an electronic message or display the secure image in a manner that allows the payor device to capture the secure image. In embodiments, a payor device 108 may be a mobile device, a smart phone, a tablet computer, a cell phone, a laptop, a computer, or any other type of general computing device as described with respect to FIG. 17. The payor device 108 may communicate with the payee device 104 and transaction core engine 110 via a network. In one embodiment, the payor device 108 may obtain the secure image by capturing a visual display of the secure image on the payee device 106. For example, the payor device 108 may capture the image using a camera or scanner that is part of or otherwise connected to the payor device 108. In other embodiments, the payee device 106 may transfer the secure image to the payor device 108 in a message sent over a network. Alternatively, payee device 106 may direct core engine 110 to send the secure image to payor device 106 or to another device where it can be accessed by the payor device 106. For example, the secure image may be transferred via email, SMS message, MMS message, push notification, or via any other type of message capable of being communicated between the payee device 106, the payor device 108, and/or core engine 110.

Upon receiving the secure image, the payor device 108 may submit the secure image to the transaction core engine 110. In embodiments, the secure image may be compressed and encrypted before sending the secure image to the transaction core engine 110. Compressing and encrypting the secure image prior to sending the secure image to the transaction core engine 110 may provide additional security to the transaction process. In embodiments, the transaction core engine 110 may identify the transaction between the payee 102 and payor 108 using the secure image. In embodiments, upon receiving the secure image, the transaction core engine 110 validates the secure image and, upon successful validation, returns transaction details to the payor device 106. The payor device 106 may then modify transaction details and send a confirmation to complete the transaction to the transaction core engine 110. Upon receiving the confirmation, the transaction core engine may confirm that the device sending the confirmation is authorized to confirm transactions. If the device is authorized, the transaction core engine 110 may perform the actions necessary to complete the transaction. In embodiments related to financial transactions, the transaction core engine 110 may send a request to the payor's financial institution system 114 to debit the payor's account and transfer funds to the payee's account. The transaction core engine 110 may also send the message to the payee's financial institution system 112 to credit the payee's account with the transferred funds. The communication between the transaction core engine 110, the payee financial institution 112, and the payor financial institution 114 allows for a real-time transfer of funds without relying upon credit and/or debit card networks. In embodiments, financial institutions 112 and 114 are part of a network of registered financial institutions with the system 100. Registered financial institutions may have additional benefits such as performing real-time deposits and credits of accounts. In other embodiments, the transaction core 110 may capture and transmit data to an ACH network (e.g., the Fed) for users who are not part of a network of registered financial institutions. Having described the operating system 100, the disclosure will now provide further detail with respect to the operation of different components of the system 100.

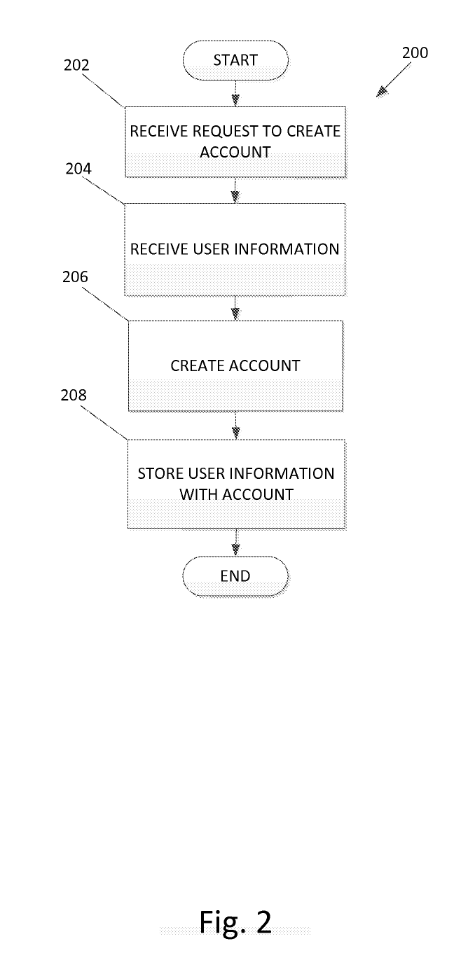

In embodiments, before participating in a transaction a user will register with an embodiment of the systems disclosed herein. For example, a user may register and create an account with the transaction core. FIG. 2 is an embodiment of a method 200 for registering a user with a transaction system. In embodiments, the method 200 may be performed by a secure server. For example, a server that is part of the transaction core 110 (FIG. 1) may perform the method 200. Flow begins at operation 202, where a request to create an account is received. Upon receiving the request, a check may be performed to ensure that the user receiving the request does not already have an account.

If the user does not have an account, flow continues to operation 204. At operation 204, user information is received. For example, information such as, but not limited to, a user name, first name, middle name, last name, address, phone number, email address, preferred method of contact, or any other information related to the user. In embodiments, financial information related to one or more user financial accounts may also be received at operation 204. Financial information may include, but is not limited to, information (such as account number(s)) about a user's checking account, savings account, credit card, debit card, etc. In embodiments, this information may be securely stored on the server and associated with the user account. In further embodiments, one or more devices may be registered with a user account. For example, the user may register one or more personal computers, tablets, laptops, smartphones, etc. In embodiments, the registration of one or more devices adds additional fraud prevention measures by limiting the performance of transactions to the one or more devices registered for the user account. Collecting this information at registration and storing it on the server allows for financial transactions to be completed without having to send sensitive financial information during the transaction process. This provides additional protection by maintaining sensitive information in a protected area.

After receiving user information at operation 204, flow continues to operation 206, where an account for the user is created. In embodiments, creating the account may include creation of a unique identifier for the user's account. Flow continues to operation 206 where the user's account and information is stored on the secure, trusted server. As noted above, storing user information at the secure server provides additional security by allowing transactions to complete without sending sensitive information, thereby removing the chance of a third party intercepting the sensitive information. As will be clearer from the following discussion, the registration process and storage of the user information provides the ability to associate a secure image with transaction information and not user information, thereby allowing the completion of transactions without exposing sensitive information.

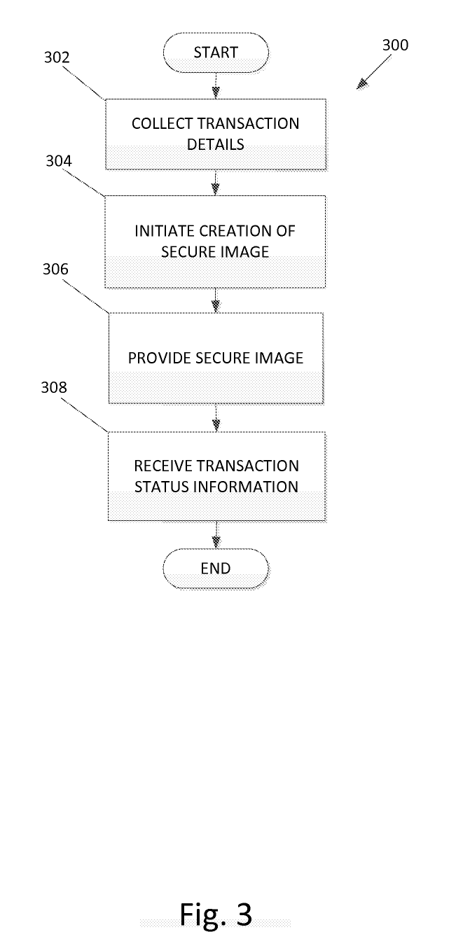

FIG. 3 is an embodiment of a flow chart illustrating a method 300 for initiating a transaction using a device such as, for example, payee device 106 in FIG. 1. In embodiments, a device may be a smart phone, a tablet, a laptop, a computer, a television, an automated teller machine (ATM), a network connected kiosk, a merchant point-of-sale (POS) terminal, or any type of general purpose computing device as described with respect to FIG. 17. In one embodiment, the method 300 may be performed by an application executing on the device. In another embodiment, the method 300 may be performed by a remote application executing on a remote device. In such embodiments, the device may access the remote application over a network, such as, but not limited to, the Internet. Flow begins at operation 302 where transaction details are received. In one embodiment, transaction details may be entered into the payee device by a user. In other embodiments, the transaction details may be retrieved from local storage on the payee device or may be retrieved from a remote device connected to the payee device over a network. The transaction details may also be received at the payee device from another application running on the payee device or another device (such as a point-of-sale application for a merchant payee). In further embodiments, the transaction details received at operation 302 may be retrieved by a combination of receiving user input, retrieving details from local device storage, and/or retrieving information from a remote device.

In embodiments, transaction details may include any type of data related to the transaction. For example, in the described embodiment where the transaction relates to a financial transaction or payment, the transaction details may include, but are not limited to, a transaction reference identifier, a name, an address, a phone number, an email address, an invoice amount, identification of a financial account registered for the payee with the transaction core engine, a description of the transaction, an IP address, a URL, or any other type of data related to the transaction. One of skill in the art will appreciate that the method 300 may be practiced in situations or transactions other than those related to a payment. In such situations, any type of information related to the situation or transaction may be received by a device at operation 302.

Flow continues to operation 304 where the creation of a secure image is initiated. In embodiments, a secure image is a unique image that represents a transaction and/or transaction details. In embodiments, a secure image may be a grid based optical representation of encoded and encrypted transaction information. In other embodiments, a secure image may be a series of concentric circles arranged as an image representation of encoded and encrypted transaction data. In a further embodiment, the secure image may be one or more graphical representations, such as, but not limited to, the graphical images previously described, superimposed or interlaced with a user selected or user uploaded image (e.g., an image uploaded upon registration, such as the registration described with respect to FIG. 2). In such embodiments, the user selected or user uploaded image may be used as the basis for providing the user with verification of a connection to an authentic, or otherwise verified, secure server. As such, the user selected or uploaded image may then be used to store secure transaction data and may be transmitted to a secure server (e.g., transaction core engine 110 in FIG. 1) for processing and verification. In other embodiments, the secure image may be a photo, a bar code, or any other unique graphic that can be used to securely identify a transaction and/or transaction details. In further embodiments, a secure image may have a set lifetime. In such embodiments, the transaction represented by the secure image may not be completed after the expiration of the secure image.

In one embodiment, initiation 304 or creation of a secure image may comprise sending a message to a remote device, such as the transaction core engine 110 in FIG. 1, over a network, such as, but not limited to, the Internet, requesting the creation of a secure image. In such embodiments, a device performing the method 300 (e.g., a payee device) may send the transaction details collected at operation 302, e.g., inputted by a user or generated by another device, along with a request to create a secure image to the remote device. In such embodiments, the remote device may process the transaction details and create the secure image, which may then be provided to the device initiating the creation of the secure image at operation 304. In an alternate embodiment, creation of the secure image may be performed by the device performing the method 300. In such embodiments, the secure image may then be provided to a remote device, such as a transaction core engine, upon the creation of the secure image at operation 304.

After initiating the creation of the secure image at operation 304, flow continues to operation 306 where the secure image is provided. In embodiments, providing the secure image may include making the secure image available to another device or application that is participating in the transaction. For example, providing the secure image at operation 306 may include making the secure image available to a device used by a payor participating in the transaction, such as payor device 104 in FIG. 1. In one embodiment, providing the secure image may include displaying the secure image on the device performing the method 300. In such embodiments, providing the secure image may include visually displaying the secure image in a way that allows another device to photograph, scan, or otherwise capture the visual display of the secure image. In a related embodiment, the secure image may be printed on paper, for example, provided on a bill or receipt at operation 306. Another device participating the transaction may photograph, scan, or otherwise capture the printed representation of the secure image.

In alternate embodiments, providing the secure image at operation 306 may include sending the secure image to another device participating in the transaction, such as, for example, a payor device. In such embodiments, the device performing the method 300 may directly send the image to the other participating device as an attachment to an email, as a SMS message, as a MMS message, push notification, or using any other type of message or means of communication supported by the devices participating in the transaction. In a related embodiment, the secure image may be provided by a remote device at operation 306. For example, in the described embodiments in which the secure image is created by, or provided to, a remote device, the device performing the method 300 may instruct the remote device to push, or otherwise provide, the secure image to another device, or devices, involved in the transaction. As such, providing the secure image may include instructing a remote device to deliver the secure image to one or more different remote devices. Although specific examples of providing a secure image have been described herein, one of skill in the art will appreciate that any method of providing an image to another device may be employed with the embodiments disclosed herein.

After providing the device, flow continues to operation 308 where the device performing the method 300 receives transaction status information. In embodiments, the transaction status information may include any information describing the transaction and may include an indication of whether the transaction was successfully completed. For example, the transaction status information may indicate that the transaction: was successfully completed, the transaction was not successfully completed, or may provide another indication. For example, in a financial transaction, an indication of whether the payor was preapproved to perform the transaction may be received at operation 308.

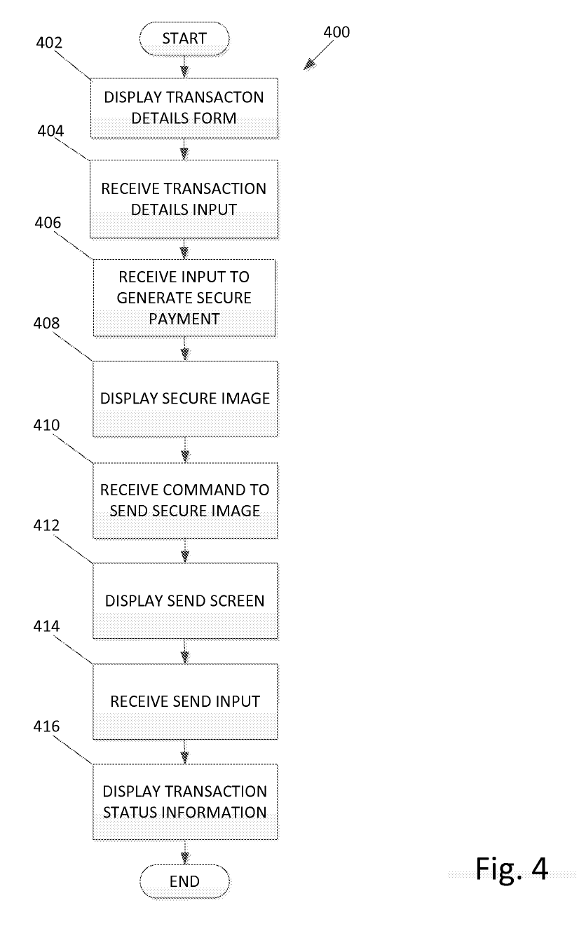

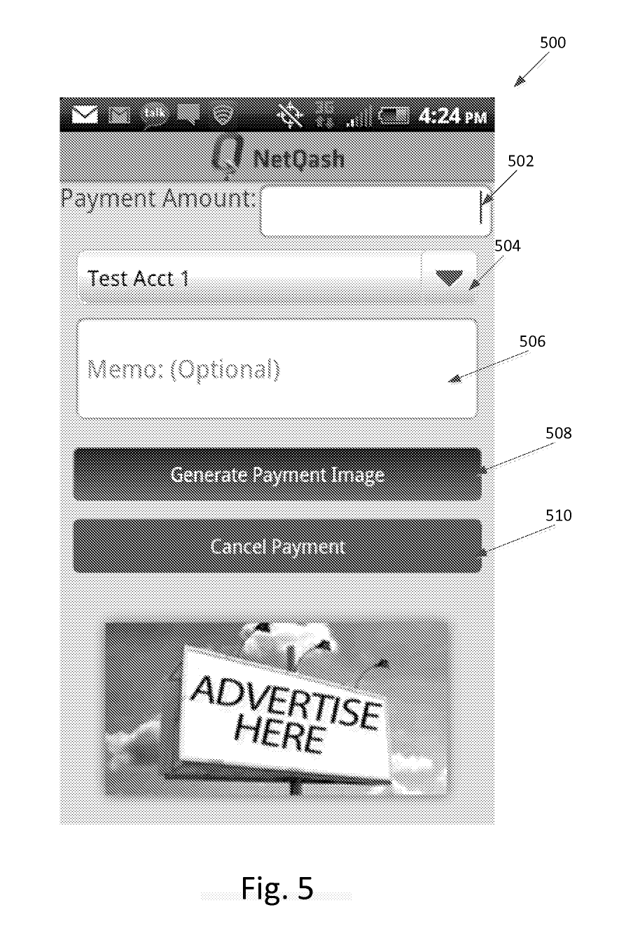

FIG. 4 is a flowchart illustrating an embodiment of a method 400 for implementing a user interface for a payee device, such as payee device 106 in FIG. 1. In embodiments, a device may be a smart phone, a tablet, a laptop, a computer, a television, and ATM, network connected kiosk, a POS terminal, or any type of general purpose computing device, including as described with respect to FIG. 17. In one embodiment, the method 400 may be performed by an application executing on the device. In another embodiment, the method 400 may be performed by a remote application executing on a remote device. In such embodiments, the device may access the remote application over a network, such as, but not limited to, the Internet. In embodiments, the method 400 may be employed to generate a user interface for an application used to initiate a transaction, for example, by performing the method 300 described in FIG. 3. For the sake of illustration, the method 400 is described with reference to the exemplary embodiments of user interface screenshots provided in FIGS. 5-8.

Flow begins at operation 402 where a transaction details form is displayed. In embodiments, the transaction details form provides one or more fields in which a user can provide information about the transaction. In embodiments, transaction details may include any type of data related to the transaction. For example, in the described embodiment where the transaction relates to a payment, the transaction details may include, but are not limited to, a name, an address, a phone number, an email address, an invoice amount, the identity of an account for the payee, a description of the transaction, an IP address, a URL, or any other type of data related to the transaction. One of skill in the art will appreciate that the method 400 may be practiced in situations or transactions other than those related to a payment. In such situations, any type of information related to the situation or transaction may be received by a device at operation 402. In such embodiments, other types of fields may be displayed on the transaction screen.

In embodiments, the transaction details form provides one or more input areas in which a user can enter transaction information. The one or more input areas may be text boxes, radio buttons, drop down menus, or any other type of graphical input field known to the art. In one embodiment, one or more fields may be prepopulated with data. For example, stored information about a payee (such as information received during registration) may be prepopulated in one or more data fields.

Flow continues to operation 404 where the device performing the method 400 receives input related to transaction details. In one embodiment, the input is received by a user interacting with the one or more input areas provided on the transaction details form. For example, a user interacting with the user interface may enter information into text boxes, select one or more buttons, and/or select information from a drop down menu. In other embodiments, the input areas may be populated from data received from a data store that is accessible to the device or may be populated by another application. The data store may be a local data store or a remote data store. In embodiments where the data is received from a data store or another application, the user may have the ability to change the received data.

FIG. 5 is an embodiment of an exemplary transaction details form 500 that may be displayed and interacted with as discussed in operations 402 and 404. The exemplary transaction details form displayed in FIG. 5 is from an example application running on a mobile device. One of skill in the art, however, will appreciate that any type of application may display a transaction details form 500 regardless of the device or environment the application operates in. The exemplary transaction details form 500 includes three input areas 502, 504, and 506. For example, input area 502 is a text input field which corresponds to a payment amount for a transaction. Input area 504 is a drop down menu which allows a user to select an account that the payment may be deposited into. In embodiments, a user may have one or more accounts at one or more financial institutions. For example, a user may have a checking account and a savings account at a bank and another savings account at a credit union. In embodiments, the different user accounts may be stored with user data and populate a drop down menu, thereby allowing a user to easily select a specific account for the payment to be deposited. Exemplary transaction details form 500 also contains a memo field 502 in which additional notes about a transaction may be entered.

Once data has been received in the transaction details form, data store, and/or another application, flow continues to operation 406 where a command is received to initiate the generation of a secure image. In one embodiment, the command may be received by a user interacting with a button that initiates the creation of the secure image.

Once the one or more input areas of transaction details form 500 have been populated, a user may activate create secure image button 508. Activating create secure image button 508 may cause the application to initiate the creation of a secure image as discussed in the embodiments described with respect to FIG. 3. In embodiments, some of the input areas may require data while others may be left unpopulated. In such embodiments, an application may require the user to enter the required information before initiating the creation of a secure image. For example, in such embodiments, the create a secure image button 508 may be disabled until all required information is provided to the one or more input areas of transaction detail form 500. In an alternate embodiment, if a user activates the create a secure image button 508 prior to entering required transaction details, a message may be displayed prompting the user to enter the missing required information. In embodiments, a cancel transaction button 510 may also be provided with transaction details form 500. Activation of the cancel transaction button 510 may allow a user to cancel the transaction.

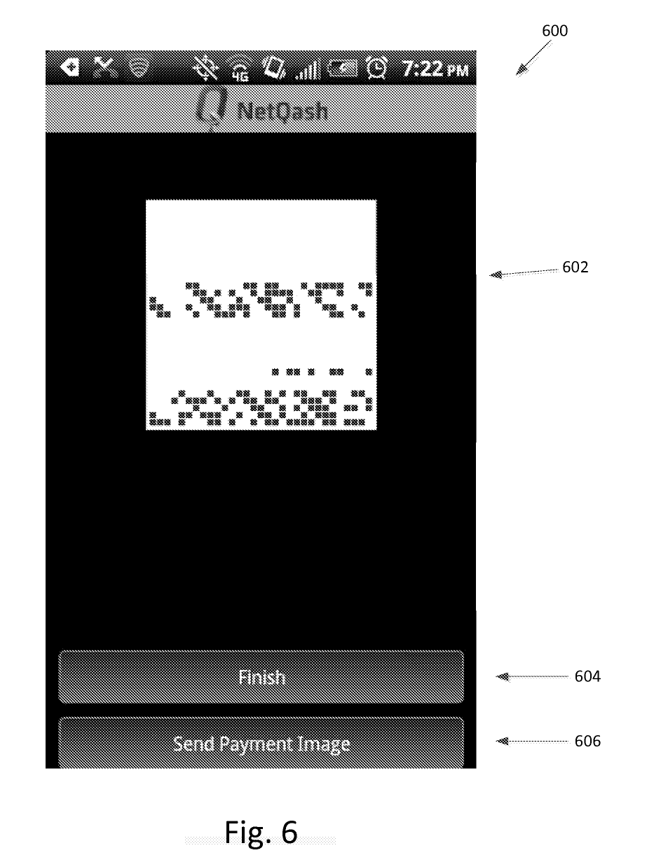

Returning to FIG. 4, upon receiving a command to initiate the generation of a secure image, flow continues to operation 408 where a secure image is displayed. In one embodiment, a secure image may be displayed on the screen of a device performing the method 400. Displaying the secure image on the device screen allows for another device participating in the transaction to capture the secure image, for example, by using a camera. FIG. 6 is an exemplary embodiment of a screenshot of a secure image display 600. In embodiments, secure image display 600 may include a display area 602 that may be used to display the secure image, such as the example secure image displayed in FIG. 6. In embodiments, the display area 602 is large enough to display the entire secure image.

Under some circumstances, displaying the secure image may be sufficient to provide the secure image to another device. For example, another device participating in the transaction may capture the displayed secure image using a camera. In such situations, a user may select the Finish button 604 to close the secure image display 600 after the other device captures the secure image. However, in some instances, the display of the secure image may not be sufficient to provide the secure image to another device. In such circumstances, the secure image display 600 may provide a Send Payment Image button 606. As will be discussed in further detail, the Send Payment Image button 606 initiates a user interface that allows for the sending of a secure image.

Returning again to FIG. 4, in some embodiments, displaying the secure image at operation 408 may be sufficient to provide the secure image to another device. However, in some circumstances the display of the secure image may not be enough. For example, if the other device participating does not have a camera or is not located within proximity of the device performing the method 400. In such situations, other means of providing the secure image may be provided. Flow continues to operation 410 where a command to send the secure image is received. For example, a user may activate a button, such as the Send Payment Image button 606 displayed in FIG. 6 thereby causing the receipt of a command to send the secure image. Flow continues to operation 412 where a send screen is displayed. In embodiments, the send screen allows a user to select a delivery method to provide the secure image to another device. For example, the send screen may provide the user with the option to deliver the secure image to another device in an email, a SMS message, an MMS message, push notification, or by any other delivery method known to the art. In additional embodiments, the send screen may provide the user the option to have the secure image delivered by a remote device. For example, in embodiments where the secure image is created by a server, such as a transaction core engine 110 from FIG. 1, the send screen may provide a graphical user interface (GUI) element that allows for the sending of the secure image by the remote device. For example, the GUI element may allow a user to select a push method of delivery for the secure image. If a push method of delivery is selected, the secure image may be provided to one or more devices involved in the transaction via a remote device.

One of skill in the art will appreciate that sending the secure image may be performed at different steps during the methods disclosed herein. For example, the payee device may provide the send instruction at the time the secure image is created too. In such embodiments the secure image may never come back to the payee device. Rather, it would be sent to the payor device, which would potentially capture it with a local application on the payor device and use it to complete the transaction. In other embodiments, the instruction could be to mail an invoice (physical or email) with the image on it.

In embodiments, the send screen may provide one or more graphical user interface (GUI) elements that allow the user to select a delivery method. In additional embodiments, the send screen may provide one or more input areas that allow a user to enter delivery information. For example, the input fields may be used to enter an email address, a phone number, an IP address, or any other type of contact information that may be used to deliver the secure image.

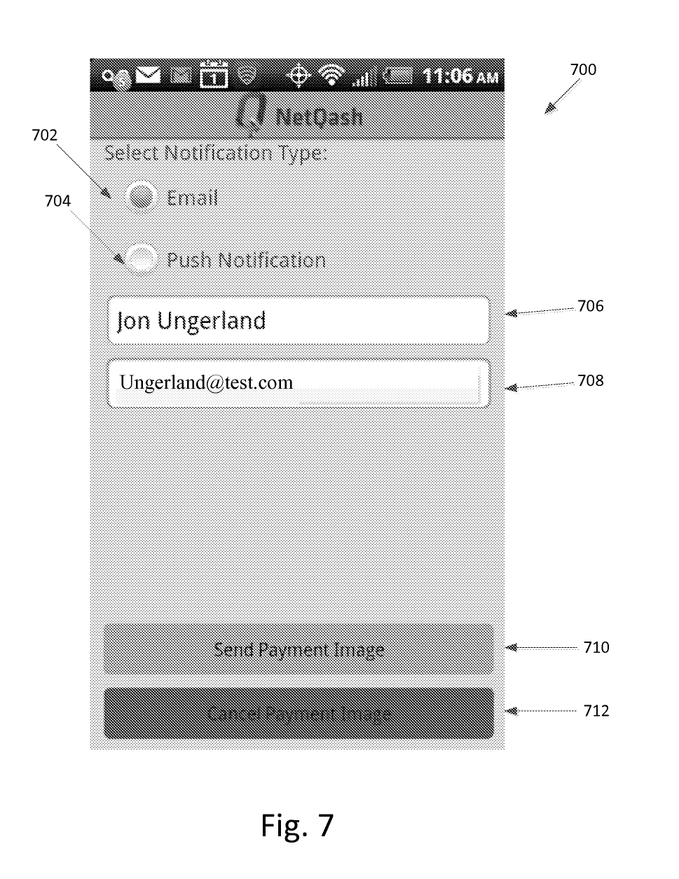

Upon displaying the send secure image screen, flow continues to operation 414 where input related to sending the secure image is received. For example, the input may be received by a user selecting one or more delivery methods and providing contact information in the send screen. FIG. 7 is an exemplary embodiment of a send screen 700 that may be displayed at operation 412 and used to receive send input at operation 414. In embodiments, the send screen 700 includes one or more buttons that allow a user to select a delivery method. For example, buttons 702 and 704 allow a user to select delivery of a secure image via email or push notification, respectively. Send screen 700 may display additional input fields in which a user may provide contact information used for delivery of the secure image. For example, text boxes 706 and 708 may be used to receive contact information such as a recipient's name and email address. This contact information may be used to deliver the secure image. In embodiments, upon receiving the send information through, for example, the displayed GUI elements, the send screen 700 may display buttons that may be activated to send the secure image (button 710) or to cancel the send operation (button 712). In embodiments, some or all of the information may be prepopulated with contact information from a data store, such as, for example, a contacts list or transaction history, accessible to a device or application performing the method 400. For example, the information may be provided from information collected during a registration process.

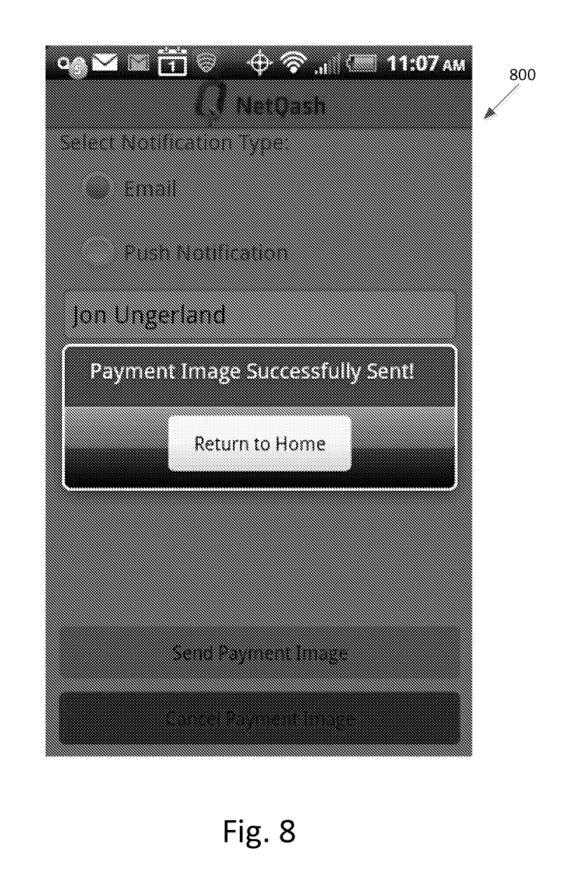

Returning to FIG. 4, in embodiments flow continues to operation 416 where transaction status information is displayed. For example, at operation 416 an indication of the success or failure of the transaction may be displayed. In embodiments, information about the transaction may be displayed along with the status indication at operation 416. In other embodiments, the indication may be provided in a pop-up window, a flowing window, or by using any other graphical feature to highlight the status of the transaction. For example, FIG. 8 is an embodiment of an exemplary transaction status screen 800. The exemplary transaction screen displays the transaction status in a floating window with the underlying window greyed out, thereby drawing the user's attention to the status of the transaction.

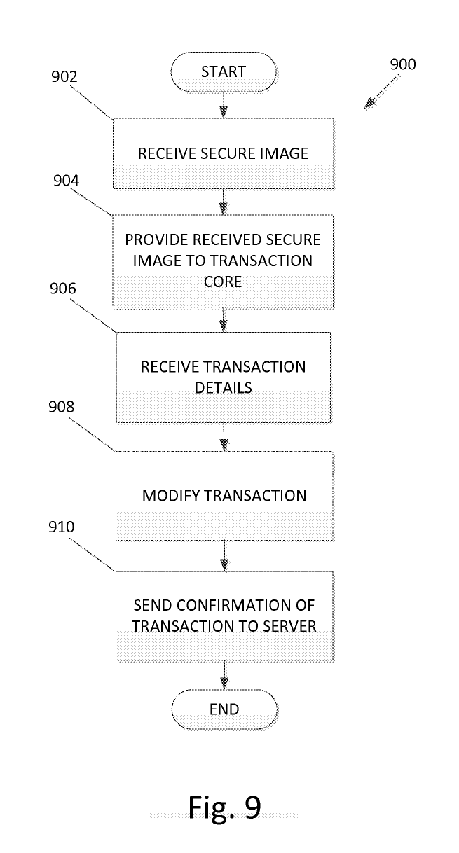

Turning now to the operation of payor device in a transaction, FIG. 9 is an embodiment of a method 900 that may be employed by a device, such as payor device 108 from FIG. 1, to complete a transaction. In embodiments, a device performing the method 900 may be a smart phone, a tablet, a laptop, a computer, a television, or any type of general purpose computing device, such as described with respect to FIG. 17. In one embodiment, the method 900 may be performed by an application executing on the device. In another embodiment, the method 900 may be performed by a remote application executing on a remote device. In such embodiments, the device may access the remote application over a network, such as, but not limited to, the Internet. Flow begins at operation 902 where a secure image is received. In one embodiment, the secure image may be received by capturing the secure image using a camera, scanner, or other input. For example, the device performing the method 900 may take a picture of a secure image displayed on another device in the transaction, such as a payee device displaying a secure image. In related embodiments, the secure image may be received by scanning a secure image from a bill, invoice, receipt, or other physical copy. In alternate embodiments, the secure image may be received over a network connection. For example, the secure image may be received in an email, in a link included in a SMS message, in an MMS message, or in any other type of message.

Upon receiving the secure image, flow continues to operation 904 where the secure image is provided to a server. In embodiments, the secure image represents a transaction. The transaction and transaction details are securely encrypted by transmitting the secure image rather than the transaction details itself. In embodiments, the security level of the transaction may be further increased if the user devices participating in the transaction (e.g., the payee and payor devices) are not capable of decoding the transaction information represented by the secure image. As such, security is increased if a remote, trusted server (e.g., a transaction core server) is used to both create and decode the secure image used in the transaction. As such, in embodiments, the secure image received by the device at operation 902 may be transmitted to a remote server for processing. In one embodiment, the secure image may be transmitted as it was captured or received at operation 902. In other embodiments, the secure image captured or received by the device at operation 902 may be compressed and/or encrypted prior to transmission to a remote server for processing (such as transaction core engine 110 in FIG. 1). Upon sending the secure image, flow continues to operation 906 the application and/or device performing the method 900 receives transaction details. For example, once the remote server processes the secure image, the actual details of the transaction may be returned to the device that provided the secure image. In embodiments, the transaction details may be encrypted. In such embodiments, the device may decrypt the transaction details upon receiving the information at operation 906. For example, an application running on the payor or payee device may be adapted to participate in an encryption algorithm shared with a core transaction server. Once the transaction details are received and decrypted, if necessary, the device performing the method 900 may display the transaction details to a user. In embodiments, the user may optionally modify, amend or augment the transaction details originally provided by the transaction initiator (e.g., payee). For example, a payor specific description or gratuity may be added to the transaction details. In such embodiments, flow continues to option operation 908 where the device receives modifications to the transaction details. At operation 908, the device may perform the modifications on the transaction details by modifying, amending, and/or augmenting the transaction details.

Flow continues to operation 910 where confirmation of the transaction (and any modification to the transaction) is sent to the server. For example, upon reviewing and optionally modifying the transaction details, a transaction may be confirmed, for example, by authorizing payment. The confirmation may be sent to a trusted server, such as, for example, a core transaction engine, to complete the transaction by initiating the transfer of funds from a payor's account to a payee's account. In embodiments, sending the confirmation at operation 910 may complete the payor's role in the transaction. Although not shown, upon sending the confirmation at operation 910, the application and/or device performing the method may receive a confirmation indicating the status of the transaction.

The embodiment described above provides a secure method to provide payment from one party to another using an open network, such as the Internet. The secure image provides security for the transaction by identifying transactions in a manner that may only be deciphered by one or more trusted servers, such as a transaction core 110 from FIG. 1. As such, the use of a secure image may prevent or otherwise limit the exposure of sensitive user identity and/or transaction information. In embodiments, even the payor device and payee device involved in the transaction may not be able to process the secure image. The secure image may represent a particular transaction between two parties. As such, any funds transferred using the secure image may only be transferred between the parties involved in the transaction. As such, the secure image may act as a secure identifier that may be transmitted over an open network, such as the Internet, without compromising security of the parties involved in the transaction, even if the secure image is intercepted by an unauthorized party because the unauthorized party will not be able to decipher any of the transaction details from the secure image alone. Furthermore, even if an unauthorized party could decipher the transaction details from the secure image, the third party would only intercept information related to the transaction, all of the parties' information would remain safe. If the unauthorized party supplies the secure image to a trusted server (such as a transaction core engine), the trusted server may determine that the device providing the secure image is not an authorized device and will not complete the transaction. However, even if the trusted sever determines that the device providing the secure image is authorized to complete the transaction, an unauthorized third party cannot intercept funds from the transaction because the secure image may be tied to the two authorized devices (and the payor and payee who registered such devices) involved in the transaction.

In embodiments, the secure image may also have a limited lifespan. For example, the secure image may include a timestamp that may be used to determine when the secure image expires. In other embodiments, a device that created the secure image, such as a secure server, may store lifetime information for the secure image upon its creation. The lifetime associated with the secure image may provide additional security against use of the image by an unauthorized party. For example, even if an unauthorized third party obtained a copy of a transaction image, the image would expire either (a) by virtue of the fact it has already been processed or (b) as a result of a predetermined expiration time, and would not be functional for any future unauthorized use by the third party.

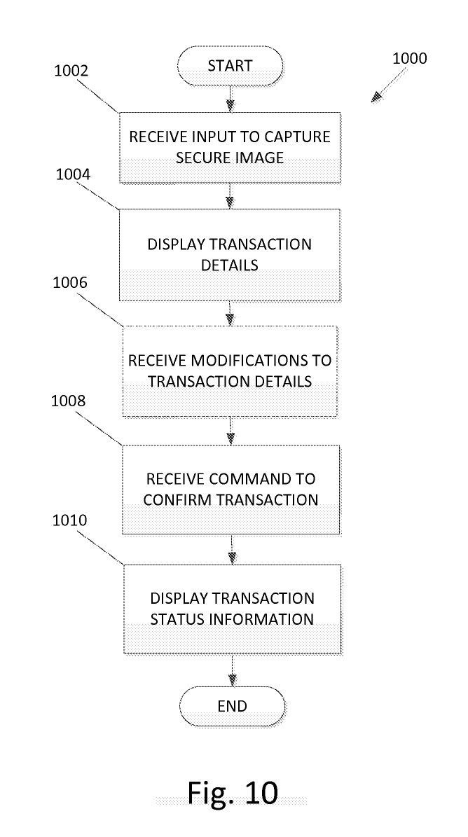

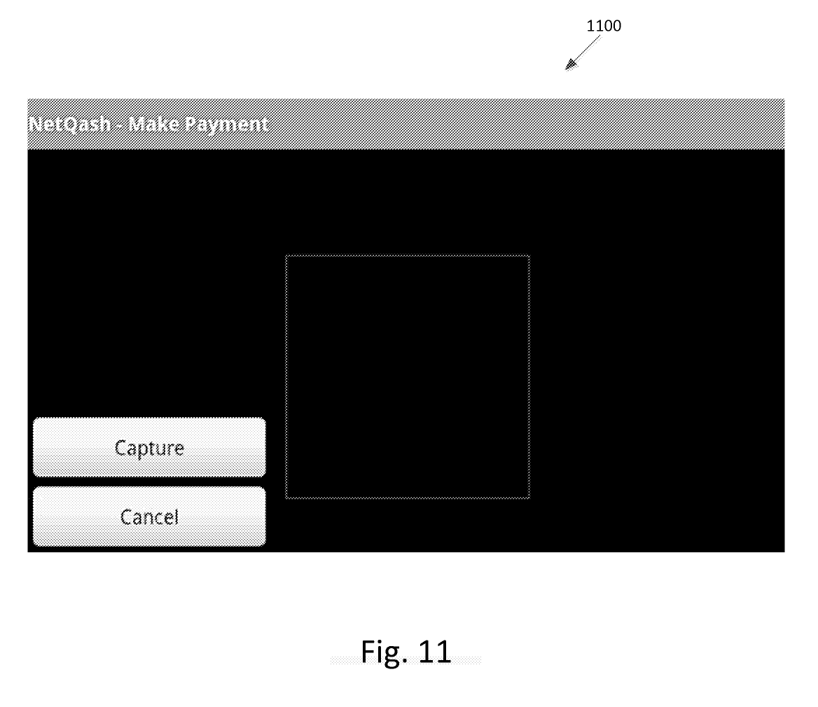

FIG. 10 is a flowchart illustrating an embodiment of a method 1000 for implementing a user interface for a payor device, such as payor device 108 in FIG. 1. In embodiments, a device may be a smart phone, a tablet, a laptop, a computer, a television, an ATM, a network connected kiosk, a POS terminal, or any type of general purpose computing device, such as described with respect to FIG. 17. In one embodiment, the method 1000 may be performed by an application executing on the device. In another embodiment, the method 1000 may be performed by a remote application executing on a remote device. In such embodiments, the device may access the remote application over a network, such as, but not limited to, the Internet. In embodiments, the method 1000 may be employed to generate a user interface for an application used to initiate a transaction, for example, by performing the method 900 described in FIG. 9. For the sake of illustration, the method 1000 is described with reference to the exemplary embodiments of user interface screenshots provided in FIGS. 11-13.

Flow begins at operation 1002 where a command is received to capture a secure image. In one embodiment, the command to capture the secure image may be received by a user directing the application to retrieve the secure image from an email, a SMS message, a MMS message, or any other type of message. In further embodiments, the input secure image may be pushed to the device performing the method 1000. In such embodiments, the push notification may include a command that, when received by the payor device, causes the payor device to capture the secure image at operation 1002. In embodiments where the secure image may be captured from the display of another device or from a print out of the secure image, receiving the command to capture the image at operation 1002 may include an instruction to capture the image using a camera, scanner, or other means of input of the device. In embodiments where the secure image is captured using, for example, a camera or scanner, the captured secure image may be automatically transmitted to a trusted server without requiring additional input from the user to send the secure image. In such embodiments, upon transferring the captured secure image to the server, the captured secure image may be removed from memory of the device that captured the secure image. In embodiments, the captured secure image may be compressed and/or encrypted prior to transferring the captured secure image to the server. One of skill in the art will appreciate that any type of compress and/or encryption may be employed with the embodiments disclosed herein. The automatic sending and removal of the secure image by the device may increase security by making the secure image inaccessible to other applications on the device, thereby restricting the transfer of the secure image between applications and devices.

FIG. 11 is an exemplary embodiment of a user interface 1100 that may be used to capture a secure image. In the exemplary embodiment, a secure image may be captured from the display of another device or from a print out of the secure image using a camera. The user interface 1100 may include a target area which may help the user line up and capture a picture of secure image. In embodiments, upon lining up the secure image within the target area, the user may cause capture the image with the camera by activating the “Capture” button. In other embodiments, a device may be able to automatically capture the secure image using a camera or other input upon recognizing the secure image. As previously described, upon capturing the image, the secure image may automatically be sent to a trusted server and then removed from the capturing device.

Returning to FIG. 10, flow continues to operation 1004 where the user interface displays the transaction details. As described in embodiments disclosed herein, upon providing a secure image to a trusted server, such as the transaction core, the trusted server may return the transaction details to the device. The received transaction details may be displayed at operation 1004. In embodiments, transaction details may include any type of data related to the transaction. For example, in the described embodiment where the transaction relates to a payment, the transaction details may include, but are not limited to, a name, an address, a phone number, an email address, an invoice amount, a gratuities amount, deposit instructions containing an American Banking Association number (ABA) for routing, an account number, a description of the transaction, an IP address, a URL, or any other type of data related to the transaction. One of skill in the art will appreciate that the method 1000 may be practiced in situations or transactions other than those related to a payment. In such situations, any type of information related to the situation or transaction may be displayed by a device at operation 1004. In such embodiments, other types of fields may be displayed on the transaction screen.

In embodiments, one or more fields of the transaction details may be augmented, amended, or otherwise modified by the user upon display at operation 1004. For example, a user may be allowed to modify a gratuity or to insert notes about the transaction. Flow continues to optional operation 1006 where the application and/or device performing the method 1000 received input detailing modifications to the transaction details. The input may be received from a user interacting with the elements of the user interface in a similar manner as described with respect to FIG. 4. In other embodiments, the input may be received from a data store and/or another application. In some embodiments, the user may be restricted from modifying certain transaction details. The user interface provided by the method 1000 may prevent the user from modifying some transaction details. Flow then continues to operation 1008 where a confirmation to proceed with the transaction is received. In embodiments, receiving the confirmation of the transaction may initiate the sending of any modifications to the transaction information as well as a command to proceed with the transaction to a trusted server, such as the transaction core.

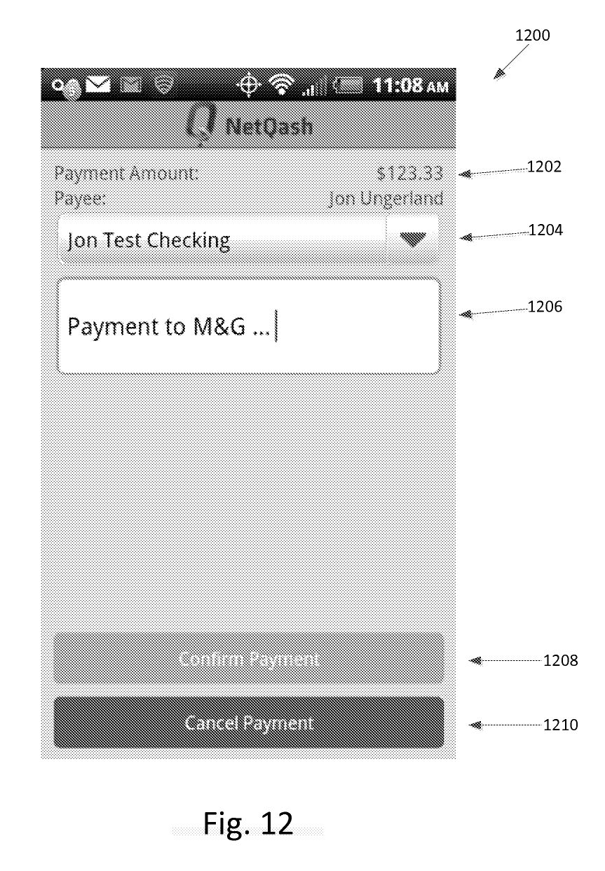

FIG. 12 is an exemplary embodiment of a transaction details screen 1200 that presents transaction details to a user. In embodiments, transaction details that may not be modified may be presented in to the user, such as the “Payment Amount” and “Payee” at the top portion 1202 of the transaction details screen 1200. In embodiments, the transaction details that cannot be modified may be displayed as static information by not including the transaction details in a user interface element that accepts user input. In embodiments, as illustrated in transaction details screen 1200 a user completing the transaction may modify or add additional transaction data to the transaction. In such embodiments, input areas such as text boxes, check boxes, radio buttons, drop down menus, or any other type of graphical user interface element may be employed with the embodiments disclosed herein. For example, a user can enter notes about a transaction in text box 1206. Furthermore, as illustrated in the exemplary embodiment of FIG. 12, a user completing a transaction may select the means in which the transaction is completed. For example, a user may associate various different accounts and/or payment methods with their account. For example, a user may associate a credit card, a checking account, a savings account, etc. As illustrated by drop down menu 1204, a user may select which account is used to draw funds from to complete the transaction. In embodiments, such information is collected during the registration process and stored on a secure sever. None of this information is stored on a party's device, thereby providing additional security in case the device is lost.

After optionally modifying the transaction information, a user may confirm the transaction by activating the “Confirm Payment” button 1208. In embodiments, when the user activates the “Confirm Payment” button 1208, any modifications made by the user may be sent to the trusted server, such as a transaction core engine, as well as an instruction to complete the transaction. Although not shown, upon confirming the payment, a user may be prompted to provide authentication to ensure that the user is allowed to confirm the transaction. For example, the user may be prompted to enter a PIN, a password, or draw a pattern on a device screen to authenticate the user. In other embodiments, voice or facial recognition software may be employed to authenticate the user. One of skill in the art will appreciate that any type of authentication may be employed upon activation of the “Confirm Payment” button 1208. Furthermore, as illustrated in FIG. 12, a user may cancel the transaction at any type by activating the “Cancel Payment” button 1210.

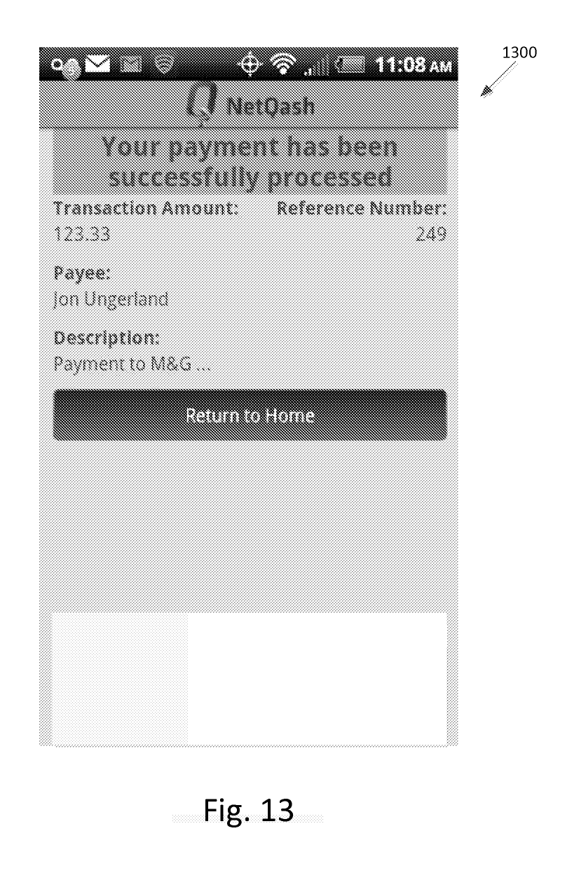

Returning to FIG. 10, upon completion receiving and sending the command to confirm the transaction, information about the transaction status may be returned. Flow proceeds to operation 1010, where the transaction status may be displayed. In embodiments, the transaction status may be displayed along with one or more of the transaction details. For example, at operation 1010 an indication of the success or failure of the transaction may be displayed. In embodiments, information about the transaction may be displayed along with the status indication at operation 1010. In embodiments, transaction status may be provided by a secure server, such as one or more servers in a transaction core, or by a third party server, such as a server from a financial institution. In other embodiments, the indication may be provided in a pop-up window, a flowing window, or by using any other graphical feature to highlight the status of the transaction. FIG. 13 is an embodiment of an exemplary transaction status screen 1300.

Having described the embodiments of methods that may be performed on the end user devices (e.g., the parties in a transaction, a payor/payee device, etc.) the disclosure now turns to the various embodiments of methods that may be performed by one or more trusted servers, such as the transaction core engine 110 described in FIG. 1. In embodiments, a trusted server is a device that is accessible to the end user devices over a network, such as, but not limited to, the Internet. In embodiments, the one or more trusted server may store account information related to the end users of a transaction. For example, before participating in a transaction, a user may have to register an account with trusted server. In embodiments, the trusted server may collect information about the user. Example information includes the users name, address, one or more account numbers, authentication information, etc. The trusted server may then create an account for the user and store the user information for use in transactions.

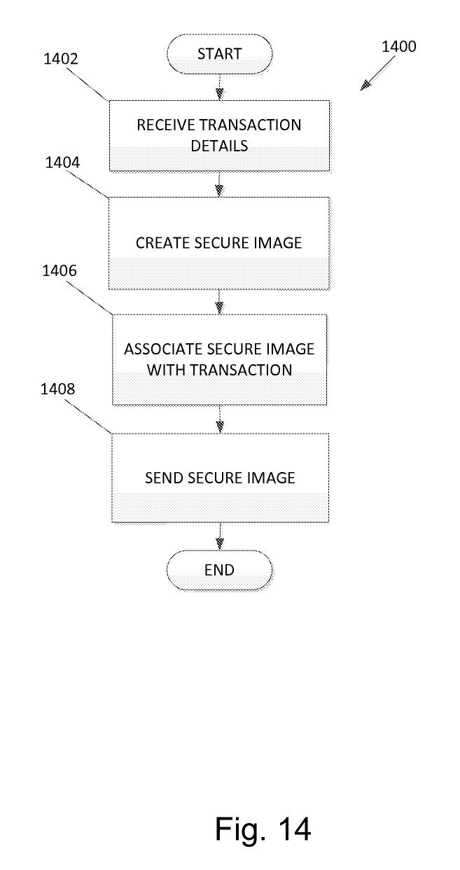

In addition to creating and storing accounts, the one or more trusted servers may be employed to process and/or complete transactions between multiple users. In embodiments, one or more trusted servers may perform different roles depending on whether the server is communicating with an initiator of a transaction (e.g., a payee) or a party completing a transaction (e.g., a payor). FIG. 14 is a flowchart illustrating an embodiment of a method 1400 for responding to a request to initiate a transaction. For example, in embodiments, method 1400 may be performed in response to receiving a request from a payee device to initiate a financial transaction. However, while the methods disclosed herein are described with reference to a financial transaction, one of skill in the art will appreciate that the method 1400 may be employed in various different situations for different types of transactions. In one embodiment, the method 1400 may be performed by a trusted server, such as server that is part of the transaction core engine 110 described in FIG. 1. In other embodiments, the method 1400 may be performed by one of the end user devices. One of skill in the art will appreciate that any type of general computing device may be employed to perform the method 1400.

Flow begins at operation 1402 where a device, such as, but not limited to, a trusted server, receives transaction details. For example, in one embodiment, the device may receive transaction details from an end user device over a network, such as, but not limited to, the Internet. In one embodiment, the transaction details may also include a command to initiate a transaction and create a secure image. In another embodiment, initiation of a transaction and creation of a secure image may be performed automatically upon receiving the transaction details at operation 1402. In a further embodiment, the transaction details received at operation 1402 may be received via user interaction with a GUI of the device performing the method 1400.

In further embodiments, a secure image may be requested via a web service or API to a secure server, such as the one or more servers from the transaction core engine 110. For example, a user may generate one or more invoices to customers via a billing platform or program that interfaces with a secure server (such as a transaction core engine 110) using an application programming interface (API). Through the interface, the billing platform may request the generation and sending secure images to customers. In such embodiments, the secure images may be delivered to the customers via an electronic invoice (e.g., an electronic message).

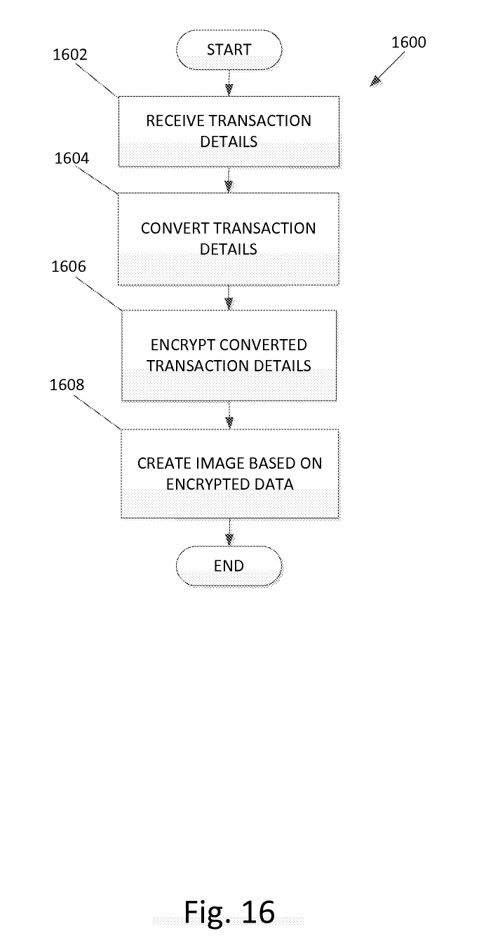

Flow continues to operation 1404 where a secure image is created. In embodiments, the secure image may be based upon the one or more transaction details received at operation 1402. In embodiments, a secure image is a unique image that may identify a transaction and/or represents the transaction details. In embodiments, the secure image may be a series of concentric circles. In embodiments, a secure image may be a grid based optical representation of encoded and encrypted transaction information. In other embodiments, a secure image may be a series of concentric circles arranged as an image representation of encoded and encrypted transaction data. In a further embodiment, the secure image may be one or more graphical representations, such as, but not limited to, the graphical images previously described, superimposed or interlaced with a user selected or user uploaded image (e.g., an image uploaded upon registration, such as the registration described with respect to FIG. 2). In such embodiment, the user selected or user uploaded image may be used as the basis for providing the user with verification of a connection to an authentic, or otherwise verified, secure server. As such, the user selected or uploaded image may then be used to store secure transaction data and may be transmitted to a secure server for processing and verification. One of skill in the art will appreciate that any type of unique image may be utilized as a secure image to identify a transaction and represent transaction details. Creation of a secure image is described with further detail in the discussion accompanying FIG. 16.

After creating the secure image, flow continues to operation 1406 where the secure image is associated with a transaction and/or one or more transaction details. In one embodiment, the transaction and/or one or more transaction details may be stored in a data store accessible to the device and/or application performing the method 1400. The secure image may be associated with the stored transaction information and/or one or more transaction details. By associating the secure image with the transaction and/or transaction details, the secure image may be used to identify the transaction and/or transaction details at a later time. In alternate embodiments, the secure image may be sent to a different device for association with the transaction and/or transaction details. In embodiments, the secure image may also be associated with information captured during registration by the parties involved in the transaction.

Flow continues to operation 1408 where the secure image is sent to one or more devices. In one embodiment, the secure image may be returned to the device that requested the secure image. In another embodiment, the secure image may be sent to another device, such as, for example, a payor device. In embodiments, sending the secure image to the one or more devices allows for the one or more devices to later identify the transaction and/or transaction details by returning the secure image to the device that associated the secure image with the transaction and/or transaction information.

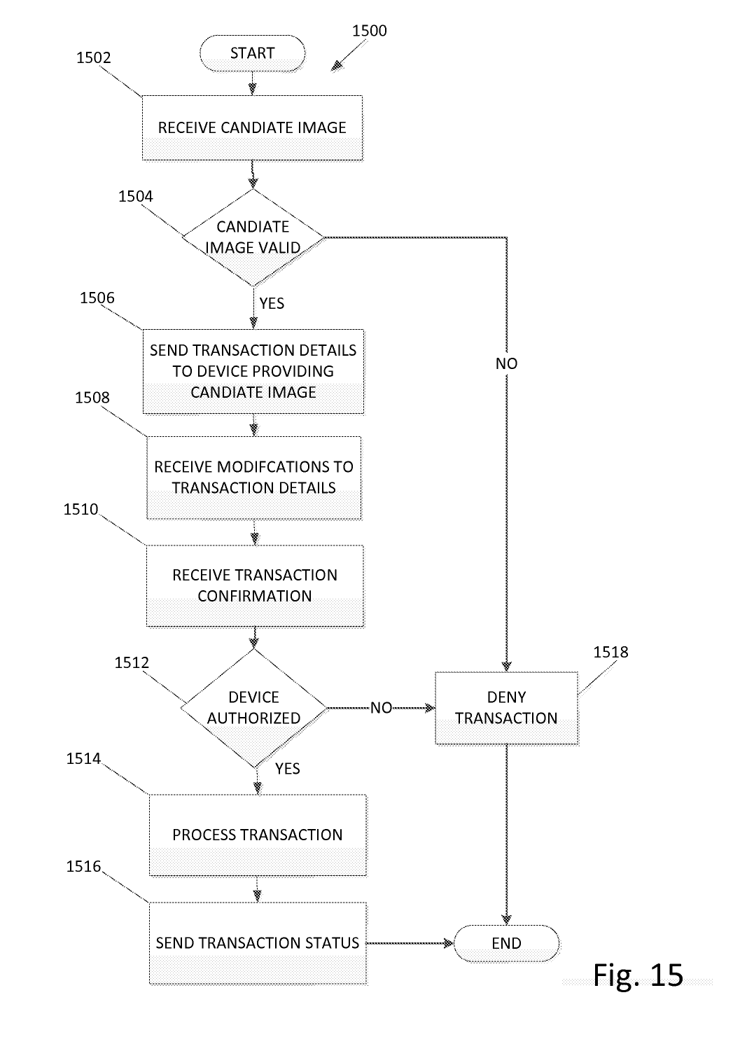

FIG. 15 is a flow chart illustrating an embodiment of a method 1500 for responding to a request to complete a transaction. For example, in embodiments, method 1500 may be performed in response to receiving a request from a payor device to complete a financial transaction. However, while the methods disclosed herein are described with reference to a financial transaction, one of skill in the art will appreciate that the method 1500 may be employed in various different situations for different types of transactions. In one embodiment, the method 1500 may be performed by a trusted server, such as server that is part of the transaction core 110 described in FIG. 1. In other embodiments, the method 1500 may be performed by one of the end user devices. One of skill in the art will appreciate that any type of general computing device may be employed to perform the method 1500.

Flow begins at operation 1502 where a candidate image is received. In embodiments, a candidate image is an image that a device is submitting as a secure image. If the candidate image is a secure image, it may be used to identify a transaction and/or transaction details. Flow continues to decision operation 1504 where the candidate image is validated. In embodiments, validation of candidate image determines whether the candidate image is a secure image. In one embodiment, the validation may be performed by matching the candidate image to a secure image that is associated with a transaction and/or transaction details. One of skill in the art will appreciate that any type of image validation may be employed at operation 1504. In further embodiments, validation of the secure image at operation 1504 may also include validating that the one or more parties to the transaction are registered parties with the transaction core. In embodiments, only registered parties may use the systems and methods disclosed herein.

If the candidate image is not validated, the image may be a fraud. In such circumstances, flow branches NO to operation 1518 and the transaction is denied. In embodiments, a status message indicating the failure to complete the transaction may be returned at operation 1518. At this point, method 1500 terminates. If the image is valid, then flow branches YES to operation 1506.

At operation 1506, one or more transaction details are provided to the sender of the candidate image. In embodiments, a sender providing a valid transaction image may be identified as an authorized party to a transaction. As such, one or more transaction details may be sent to the sender at operation 1506.

Flow continues to operation 1508. At operation 1508 one or more amendments, augmentations, and/or modifications to the transaction details are received in response to providing the transaction details at operation 1506. In embodiments, upon receiving the additions and/or modifications at operation 1508, the received details may be stored store along with the other transaction details, such as, for example, any transaction details received during the initiation of the transaction as described with respect to FIG. 14. In embodiments, upon receiving any modifications, the device performing the method 1500 may validate that the modifications are allowable.

Flow continues to operation 1512 where a transaction confirmation is received. In embodiments, the transaction confirmation may be a request to complete the transaction as provided in the transaction details as originally presented or as modified. Flow continues to decision operation 1516 where a determination is made as to whether the device providing the confirmation is authorized to complete the transaction. In one embodiment, a determination may be performed by comparing a password or pin number received with the confirmation to a password stored for a particular user. In another embodiment, the location of the device may be used to confirm whether the user of the device is authorized to complete the transaction. For example, geographic location of the device that sent the confirmation may be compared to a known location of the authorized user. If the geographic location differs from the known location, a determination may be made that an unauthorized user is attempting to complete a transaction. In embodiments, the verification may be geographical. For example, if the secure image is captured by a camera, the verification may check to see that the capturing device (e.g., payor device) is in physical proximity to the display device (e.g., payee device). While specific methods of authorization are described herein, one of skill in the art will appreciate than any type of authorization may be performed at operation 1512.

If the device and/or user of the device is not authorized to confirm the transaction then the confirmation may be an attempt at a fraudulent transaction. In such circumstances, flow branches NO to operation 1518 and the transaction is denied. In embodiments, a status message indicating the failure to complete the transaction may be returned at operation 1518. At this point, method 1500 terminates. If the device and/or user are authorized to confirm the transaction, then flow branches YES to operation 1514.

At operation 1514 the transaction is processed. In embodiments, processing the transaction may include performing any actions necessary to complete the transaction. For example, in a financial transaction, processing the transaction at operation 1514 may include contacting the financial institutions of the parties involved in the transaction. For example, a message may be sent to the financial institution to debit the account of the payor and transfer money to the account of the payee. Additionally, a message may be sent to the financial institution of the payee to credit the account of the payee in anticipation of receiving a transfer of funds from the payor's account. In such embodiments, the transfer of funds from the accounts may be performed in real-time. In another embodiment, processing the transaction may include providing a preauthorization for the payor to perform the transaction. In such embodiments, the actual transfer of funds between the payor and payee accounts may be performed at a later time. While specific embodiments related to financial transactions are provided herein, one of skill in the art will appreciate that the embodiments disclosed herein are not limited to financial transactions. In situations involving other types of transactions, any actions necessary to complete the transaction may be performed at operation 1514.

After processing the transaction, flow continues to operation 1516 where one or more transaction status messages may be sent to the various parties involved in the transaction. The transaction status may include information about the transaction as well as an indication as to whether the transaction was successfully completed.

FIG. 16 is an embodiment of a method 1600 for performing a method of creating a secure image. In embodiments, a secure image is a unique image that may be used to represent a transaction and/or transaction details. The secure image may be transferred between parties of the transaction rather than the actual transaction or account details, thereby ensuring against an unauthorized third party from intercepting any transaction details or account information. As such, the participants in a transaction are assured that no sensitive information is put at risk. Flow begins with operation 1602 where the transaction details are received. Flow continues to operation 1604 where, in embodiments, the transaction details are converted. In one embodiment, the transaction details may be converted to binary, octal, or hex values. In other embodiments, any type of conversion may be employed at operation 1604.

Flow continues to operation 1606 where the converted transaction data is encrypted. In embodiments, the converted transaction data may be encrypted by hashing the conversion values with a reference identifier. In other embodiments, any type of encryption algorithm may be employed at operation 1606. After encrypting the data, flow continues to operation 1608 where an image is generated based off of the encrypted data. For example, the encrypted data may be used as input to a graphics function to generate a unique, secure image. In embodiments, the image generated at operation 1608 may be provided as a secure image. In another embodiment, the generated image may overlay or be subtracted from an image selected by the user. The image may be provided or selected during the registration process. Overlaying or subtracting the generated image on an image provided by the user provides additional security by allowing selection of a particular image for transactions and may provide additional assurance to a user that he/she is connected to an authenticated secure server. Additionally, allowing the user to select the image provides additional branding benefits.

Although specific examples have been provided herein in which a payee (or payee device) initiates a financial transaction, one of skill in the art will appreciate that a payor (or payor device) may also initiate a transaction. In such embodiments, the methods for initiating a transaction described herein may be employed to collect information related to a debt being paid by one party to another (as opposed to a debt being owed). In such embodiments, a payor may provide transaction details related to the debt being paid. A secure image may be created to represent the payment and may be transferred to another device, such as a payee device, using the various methods of transferring secure images disclosed herein. Furthermore, in such embodiments the payee would act as a party completing the transaction and performing the methods for doing so described herein. For example, the payee device may capture the secure image identifying the payment, submit the secure image to a trusted server, received details about the payment, and confirm the transaction. As such, one of skill in the art will appreciate that the methods for initiating and completing a transaction disclosed herein may be performed by either a payee device or payor device within a financial transaction.

Furthermore, while embodiments have been described with respect to performing financial transactions, one of skill in the art will appreciate that other types of transactions may be performed using the systems and methods disclosed herein. Although references may be made to an action being performed by one or more parties in a transaction (e.g., a payor or a payee or a transaction initiator), one of skill in the art will appreciate that the functionality described herein may be performed by a device associated with the party and not the parties themselves.

With reference to FIG. 17, an embodiment of a computing environment for implementing the various embodiments described herein includes a computer system, such as computer system 1700. Any and all components of the described embodiments (such as the DVR, the content storage sever, a laptop, mobile device, personal computer, network connected kiosk, ATM, POS terminal, etc.) may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 1700 comprises at least one processing unit or processor 1704 and system memory 1706. The most basic configuration of the computer system 1700 is illustrated in FIG. 17 by dashed line 1702. In some embodiments, one or more components of the described system are loaded into system memory 1706 and executed by the processing unit 1704 from system memory 1706. Depending on the exact configuration and type of computer system 1700, system memory 1706 may be volatile (such as RAM), non-volatile (such as ROM, flash memory, etc.), or some combination of the two.

Additionally, computer system 1700 may also have additional features/functionality. For example, computer system 1700 may include additional storage media 1708, such as removable and/or non-removable storage, including, but not limited to, magnetic or optical disks or tape. In some embodiments, software or executable code and any data used for the described system is permanently stored in storage media 1708. Storage media 1708 includes volatile and non-volatile, removable and non-removable media implemented in any method or technology for storage of information such as computer readable instructions, data structures, program modules, or other data.

System memory 1706 and storage media 1708 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information and which is accessed by computer system 1700 and processor 1704. Any such computer storage media may be part of computer system 1700. In some embodiments, system memory 1706 and/or storage media 1708 may store data and/or computer executable instructions used to perform the methods or form the system(s) disclosed herein. In other embodiments, system memory 1706 may store transaction algorithm instructions 1714 to perform the various transaction methods disclosed herein and/or secure images 1716.

Computer system 1700 may also contain communications connection(s) 810 that allow the device to communicate with other devices. Communication connection(s) 1710 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, secure images, transaction details, commands to perform transactions, and/or request to create secure images may be transmitted over communications connection(s) 1710.

In some embodiments, computer system 1700 also includes input and output connections 1712, and interfaces and peripheral devices, such as a graphical user interface. Input device(s) are also referred to as user interface selection devices and include, but are not limited to, a keyboard, a mouse, a pen, a voice input device, a touch input device, touch screens, etc. Output device(s) are also referred to as displays and include, but are not limited to, cathode ray tube displays, plasma screen displays, liquid crystal screen displays, speakers, printers, etc. These devices, either individually or in combination, connected to input and output connections 1712 are used to display the information as described herein. All these devices are well known in the art and need not be discussed at length here.

In some embodiments, the component described herein comprise such modules or instructions executable by computer system 1700 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 1700 is part of a network that stores data in remote storage media for use by the computer system 1700.

This disclosure described some embodiments of the present invention with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the invention is not limited to those specific embodiments. One skilled in the art will recognize other embodiments or improvements that are within the scope and spirit of the present invention. Therefore, the specific structure, acts, or media are disclosed only as illustrative embodiments. The scope of the invention is defined by the following claims and any equivalents therein.

What is claimed is:

1. A method of participating in a transaction using a first device, the method comprising:
receiving one or more transaction details for a transaction;
initiating a creation of a secure image, wherein the secure image is a unique image that represents the one or more transaction details; and
providing the secure image to a second device.

2. The method of claim 1, wherein providing the secure image to the second device comprises displaying the secure image on the first device.

3. The method of claim 1, wherein providing the secure image to the second device comprises sending the secure image to the second device.

4. The method of claim 1, wherein the first device is a payee device.

5. The method of claim 1, wherein the first device is a payor device.

6. The method of claim 1, wherein initiating the creation of the secure image comprises:
sending a request to a server to create the secure image; and
sending the one or more transaction details to the server.

7. The method of claim 1, further comprising:
prior to initiating creation of the secure image, sending user information to a transaction core engine, including financial information;
wherein the secure image represents the one or more transaction details and does not represent the financial information.

8. A method of participating in a transaction using a device, the method comprising:
receiving a secure image, wherein the secure image is a unique image that represents the one or more transaction details of a transaction;
sending the secure image to a transaction core engine;
in response to sending the secure image to the transaction core engine, receiving, from the transaction core engine, the one or more transaction details;
displaying the one or more transaction details; and
sending, to the transaction core engine, confirmation of the transaction.

9. The method of claim 8, wherein receiving the secure image comprises one of capturing the secure image and taking a picture of the secure image.

10. The method of claim 8, wherein receiving the secure image comprises receiving the secure image in at least one of:
an email;
an SMS message;
a MMS message;
a push notification;
an electronic invoice;
an instant message.

11. The method of claim 8, further comprising prior to sending the confirmation of the transaction, modifying the one or more transaction details.

12. The method of claim 11, wherein modifying the one or more transaction details comprises adding gratuity.

13. The method of claim 8, wherein the one or more transaction details comprise at least one of:
a transaction reference identifier;
an invoice amount; and
a gratuity amount.

14. The method of claim 8, further comprising prior to sending confirmation to the server, verifying that a user of the device is authorized to confirm the transaction.

15. A computer readable medium comprising computer-executable code that, when executed by at least one processor, perform a method for processing payment transactions, the method comprising:
Receiving one or more transaction details from a first device;
creating a secure image, wherein the secure image is a unique image that represents the transaction information;
sending the secure image;
receiving a candidate image from a second device;
determining whether the candidate image and the secure image are the same;
when the candidate image and the secure image are the same, sending the transaction details to the second device; and
receiving a transaction confirmation from the second device.

16. The computer readable medium of claim 15, wherein the method further comprises in response to receiving a transaction confirmation from the second device, providing a response.

17. The computer readable medium of claim 16, wherein providing the response comprises sending a confirmation to the first device.

18. The computer readable medium of claim 16, further comprising:
prior to creating the secure image, receiving user information including financial information;
wherein the secure image represents the one or more transaction details and does not represent the financial information.

19. The computer readable medium of claim 15, wherein the method further comprises authenticating the second device.

20. The computer readable medium of claim 19, wherein authenticating the second device comprises checking the location of the second device against a known location for the first device.
